(19) United States
(12) Patent Application Publication
(10) Pub. No.: US 2026/0126128 A1
(43) Pub. Date: May 7, 2026

(54) FAUCET

(71) Applicant: Shanghai Aquacubic Sanitaryware Co., Ltd, Shanghai (CN)

(72) Inventor: Ruizhi Ling, Shanghai (CN)

(21) Appl. No.: 19/437,467

(22) Filed: Dec. 31, 2025

(30) Foreign Application Priority Data
Nov. 27, 2025 (CN) 202522526709.1

(51) Int. Cl. F16K 31/143; F16K 15/18; F16K 27/12

(52) U.S. Cl. CPC F16K 31/143; F16K 15/184; F16K 27/12

(57) ABSTRACT

A faucet includes a valve body. A water inlet pipe and a water outlet pipe are longitudinally or transversely arranged in the valve body. A transfer cavity is formed in an upper end inside the valve body, the water outlet pipe is connected to a side surface of the transfer cavity, a piston is provided inside the transfer cavity, and an upper end of the transfer cavity is communicated with external atmosphere. The water inlet pipe includes a first pipe and a second pipe. The second pipe communicates with a bottom of the transfer cavity and a valve core, and the first pipe communicates with the valve core and a water source. The valve core is arranged on one side of the valve body, and a hand wheel is provided outside the valve core and is configured to open and close the valve core.

### TECHNICAL FIELD

The present disclosure relates to the technical field of water supply devices, and in particular, to a faucet.

### BACKGROUND

The faucet is one of the most commonly used water-dispensing components. However, during use, it often faces the issue that when turned off, residual liquid remains inside the pipeline, which can lead to backflow and contaminate the clean water supply, thereby affecting normal operation.

To address this issue, in the prior art, Chinese patent CN205824315U titled “Frost-Proof and Anti-Siphon Wall-Mounted Faucet” incorporates an air inlet hole and an air inlet head in a right valve body, constituting an anti-siphon structure to prevent backflow and contamination. However, this art still carries a risk of backflow when the faucet is in a semi-open or semi-closed state.

Therefore, to effectively solve the above problem, there is an urgent need to develop relevant technical solutions. In view of this, the present application is specifically proposed.

### SUMMARY

An objective of the present disclosure is to provide a faucet to solve the above problem.

To achieve the above objective, the present disclosure specifically adopts the following technical solution:

Provided is a faucet, including: a valve body, where
a water inlet pipe and a water outlet pipe are provided in the valve body, and both the water inlet pipe and the water outlet pipe are longitudinally or transversely arranged in the valve body;
a transfer cavity is formed in an upper end inside the valve body, the water outlet pipe is connected to a side surface of the transfer cavity, a piston is provided inside the transfer cavity, and an upper end of the transfer cavity is communicated with external atmosphere;
the water inlet pipe includes a first pipe and a second pipe, where the second pipe communicates with a bottom of the transfer cavity and a valve core, and the first pipe communicates with the valve core and a water source; and
the valve core is arranged on one side of the valve body, a hand wheel is provided outside the valve core, and the hand wheel is configured to open and close the valve core.

In some embodiments, an air inlet cover is connected to an upper end of the transfer cavity, and an upper end of the air inlet cover has a hollow structure, allowing air to be able to enter the transfer cavity.

In some embodiments, a dustproof cover is fixed to the upper end of the air inlet cover, and a gap is left between the dustproof cover and the air inlet cover, allowing air to be able to enter the transfer cavity.

In some embodiments, a support rod is provided at a bottom of the air inlet cover, the piston is slidably connected to the support rod, and the piston is adapted to an inner diameter of the transfer cavity.

In some embodiments, a recess is formed in one end of the second pipe, a protrusion is provided at a lower end of the piston, a first sealing ring is provided outside the protrusion, and the protrusion and the first sealing ring are inserted into and adapted to the recess; and a second sealing ring is provided at an upper end of the piston.

In some embodiments, a size of a junction between the transfer cavity and the water outlet pipe is not greater than an inner size of the piston.

In some embodiments, the water inlet pipe is a single cold water pipe or a dual hot-and-cold water pipe.

The beneficial effects of the present disclosure are as follows:

In the present disclosure, the transfer cavity is formed in the upper end inside the valve body, the water outlet pipe is connected to the side surface of the transfer cavity, the piston is provided inside the transfer cavity, and the upper end of the transfer cavity is communicated with the external atmosphere. When there is a negative pressure in the transfer cavity, that is, when backflow is about to occur, the piston moves downward under the action of the negative pressure to block the transfer cavity and a water outlet of the water inlet pipe, thereby effectively preventing a pollution source from flowing back from the water outlet pipe to pollute the water source.

In order to explain the structural features and effects of the present disclosure more clearly, it will be described in detail below in combination with the accompanying drawings and specific embodiments.

### BRIEF DESCRIPTION OF THE DRAWINGS

FIG. 1 is a stereoscopic view of a single-cold faucet according to the present disclosure;

FIG. 2 is a sectional view of a single-cold faucet according to the present disclosure;

FIG. 3 is a partial sectional view of a single-cold faucet according to the present disclosure;

FIG. 4 is a stereoscopic view of a hot-and-cold faucet according to the present disclosure; and

FIG. 5 is a schematic diagram of another embodiment of a faucet according to the present disclosure.

Reference Numerals: 1. Valve body; 2. Water inlet pipe; 201. First pipe; 202. Second pipe; 3. Water outlet pipe; 4. Transfer cavity; 5. Piston; 6. Valve core; 7. Hand wheel; 8. Air inlet cover; 9. Dustproof cover; 10. Support rod; 11. Recess; 12. Protrusion; 13. First sealing ring; 14. Second sealing ring; 15. Retaining nut; and 16. Threads.

### DETAILED DESCRIPTION OF THE EMBODIMENTS

To make the objective, technical solutions, and advantages in the embodiments of the present disclosure clearer, the technical solutions in the embodiments of the present disclosure are clearly and completely described below with reference to the accompanying drawings in the embodiments of the present disclosure.

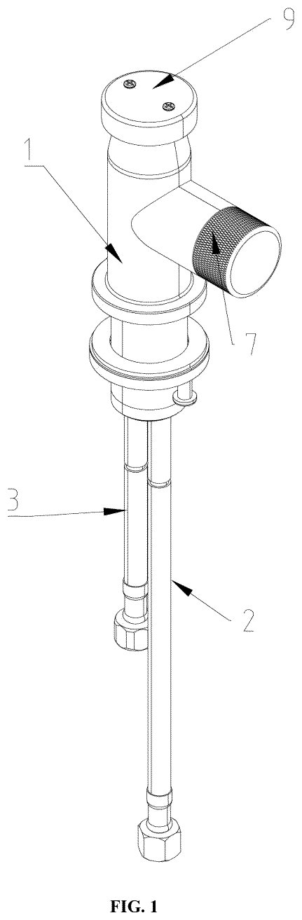

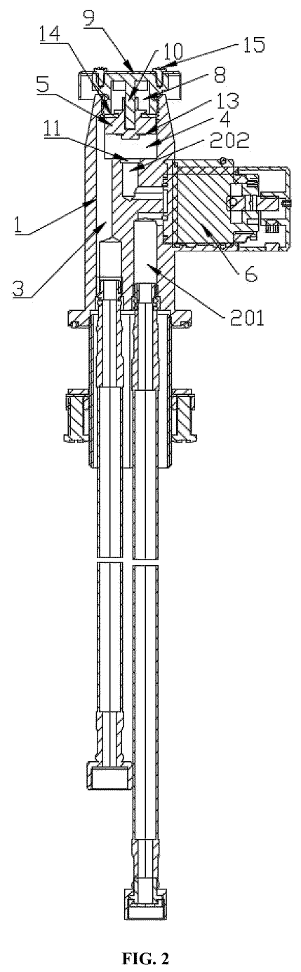

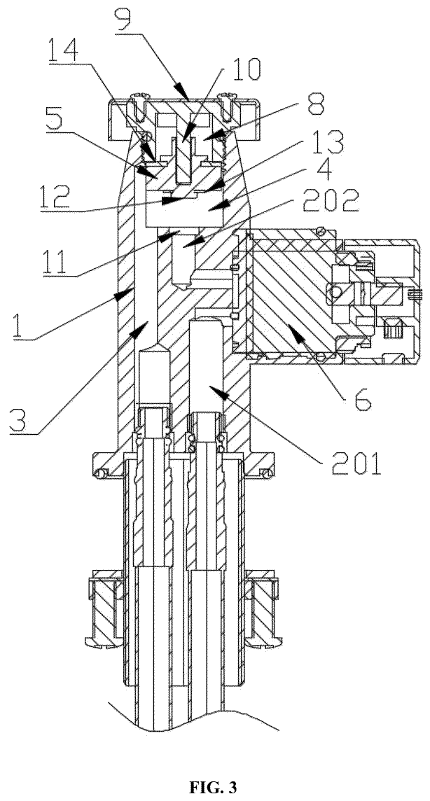

As shown in FIG. 1 to FIG. 3, in one embodiment, a faucet is specifically a single-cold faucet, in which a water inlet pipe 2 is a single cold water pipe, specifically:

The water inlet pipe 2 and a water outlet pipe 3 are provided in a valve body 1, and both the water inlet pipe 2 and the water outlet pipe 3 are longitudinally arranged in the valve body 1. The advantage of this longitudinal arrangement is that, even if liquid remains in the water outlet pipe 3, it must overcome gravity to flow back into the water inlet pipe 2, preventing the backflow of residual liquid to some extent. In some embodiments, the water inlet pipe 2 and the water outlet pipe 3 can also be transversely arranged in the valve body 1.

A transfer cavity 4 is formed in an upper end inside the valve body 1, the water outlet pipe 3 is connected to a side surface of the transfer cavity 4, a piston 5 is provided inside the transfer cavity 4, and an upper end of the transfer cavity 4 is communicated with external atmosphere. When there is a negative pressure in the transfer cavity 4, that is, when backflow is about to occur, the piston 5 moves downward under the action of the negative pressure to block the transfer cavity 4 and a water outlet of the water inlet pipe 2, thereby effectively preventing a pollution source from flowing back from the water outlet pipe 3 to pollute the water source.

The water inlet pipe 2 includes a first pipe 201 and a second pipe 202, where the second pipe 202 communicates with a bottom of the transfer cavity 4 and a valve core 6, and the first pipe 201 communicates with the valve core 6 and the water source. When the piston 5 is in a semi-open and semi-closed state, that is, the piston 5 only blocks a portion of the transfer cavity 4, the water inlet pipe 2 is divided into the first pipe 201 and the second pipe 202. Even if the pollution source enters the second pipe 202, when the valve core 6 is closed, the pollution source can still be prevented from proceeding into the first pipe 201 and reaching the water source, thereby further protecting the water supply.

The valve core 6 is arranged on one side of the valve body 1, a hand wheel 7 is provided outside the valve core 6, and the hand wheel 7 is configured to open and close the valve core 6. The hand wheel 7 can be rotated to switch a state in which the valve core 6 is connected to the first pipe 201 or the second pipe 202, i.e., a state in which the valve core 6 is opened or closed, thereby controlling water outflow.

In one embodiment, an air inlet cover 8 is connected to an upper end of the transfer cavity 4, and an upper end of the air inlet cover 8 has a hollow structure, allowing air to be able to enter the transfer cavity 4. The air inlet cover 8 can allow the air to enter the transfer cavity 4. When the negative pressure is generated in the transfer cavity 4, the piston 5 can move downward to block the transfer cavity 4.

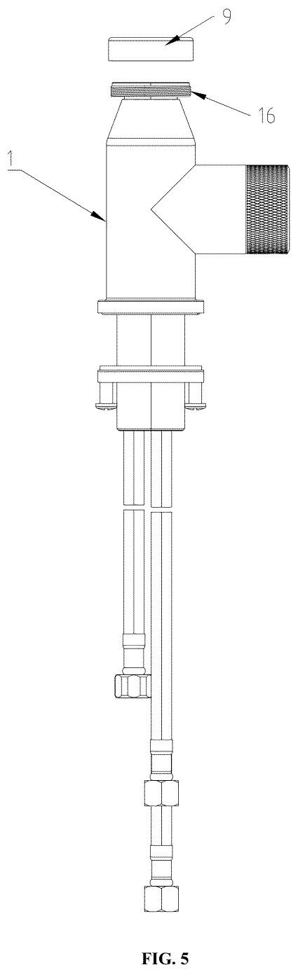

In one embodiment, a dustproof cover 9 is fixed to the upper end of the air inlet cover 8, and a gap is left between the dustproof cover 9 and the air inlet cover 8, allowing air to be able to enter the transfer cavity 4. The arrangement of the dustproof cover 9 can reduce dust and impurities from directly falling into a space above the piston 5 to affect normal motion of the piston 5 such as rebound. The dustproof cover 9 is fixed by a retaining nut 15. As shown in FIG. 5, in some embodiments, the dustproof cover 9 is fixed above the air inlet cover 8 through threads. The dustproof cover may be made of a metal material, and the threads are made of a polyoxymethylene (POM) material.

In one embodiment, a support rod 10 is provided at a bottom of the air inlet cover 8, the piston 5 is slidably connected to the support rod 10, and the piston 5 is adapted to an inner diameter of the transfer cavity 4. Because the support rod 10 is adapted to the inner diameter of the transfer cavity 4, the piston 5 can move along a fixed path, such as an axial direction of the transfer cavity 4, to prevent a gap from forming between the piston 5 and the transfer cavity 4 to cause liquid leakage, or to prevent the piston 5 from being stuck in the transfer cavity 4 to cause dysfunction and other problems.

In one embodiment, a recess 11 is formed in one end of the second pipe, a protrusion 12 is provided at a lower end of the piston 5, a first sealing ring 13 is provided outside the protrusion 12, and the protrusion 12 and the first sealing ring 13 are inserted into and adapted to the recess 11. When the piston 5 is reset, the mating between the recess 11 and the first sealing ring 13 can prevent liquid leakage and other problems, but still part of the pollution source flows back to the water source.

A second sealing ring 14 is provided at the upper end of the piston 5, and when the piston 5 moves upward, the second sealing ring can prevent leakage.

In one embodiment, a size of a junction between the transfer cavity 4 and the water outlet pipe 3 is not greater than an inner size of the piston 5. Therefore, it is ensured that when the piston 5 moves to the bottommost part of the transfer cavity 4, the junction of the water outlet pipe 3 can be completely blocked to prevent backflow.

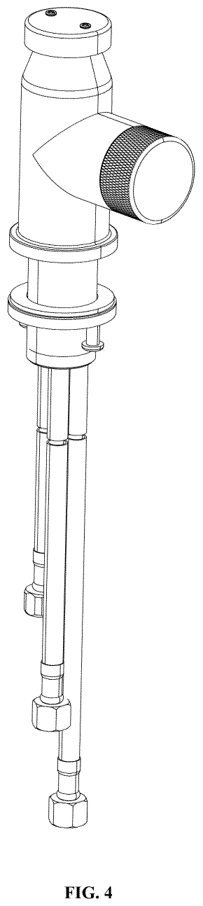

In some embodiments, FIG. 4 shows a faucet with a dual hot-and-cold water pipe, which differs from the above embodiment in that the water inlet pipe 2 is a dual hot-and-cold water pipe, realizing the supply of cold water and hot water. The above description of the disclosed embodiments can enable a person skilled in the art to implement or practice the present disclosure. Various modifications to these embodiments are readily apparent to those skilled in the art, and the generic principles defined herein may be practiced in other embodiments without departing from the spirit or scope of the present disclosure. Accordingly, the present disclosure will not be limited to these embodiments shown herein, but fall within the widest scope consistent with the principles and novel features disclosed herein.

What is claimed is:

1. A faucet, comprising: a valve body, wherein
a water inlet pipe and a water outlet pipe are provided in the valve body, and both the water inlet pipe and the water outlet pipe are longitudinally or transversely arranged in the valve body;
a transfer cavity is formed in an upper end inside the valve body, the water outlet pipe is connected to a side surface of the transfer cavity, a piston is provided inside the transfer cavity, and an upper end of the transfer cavity is communicated with external atmosphere;
the water inlet pipe comprises a first pipe and a second pipe, wherein the second pipe communicates with a bottom of the transfer cavity and a valve core, and the first pipe communicates with the valve core and a water source; and
the valve core is arranged on one side of the valve body, a hand wheel is provided outside the valve core, and the hand wheel is configured to open and close the valve core.

2. The faucet according to claim 1, wherein an air inlet cover is connected to an upper end of the transfer cavity, and an upper end of the air inlet cover has a hollow structure that allows air to be able to enter the transfer cavity.

3. The faucet according to claim 2, wherein a dustproof cover is fixed to the upper end of the air inlet cover, and a gap is left between the dustproof cover and the air inlet cover, allowing air to be able to enter the transfer cavity.

4. The faucet according to claim 2, wherein a support rod is provided at a bottom of the air inlet cover, the piston is slidably connected to the support rod, and the piston is adapted to an inner diameter of the transfer cavity.

5. The faucet according to claim 1, wherein a recess is formed in one end of the second pipe, a protrusion is provided at a lower end of the piston, a first sealing ring is provided outside the protrusion, and the protrusion and the first sealing ring are inserted into and adapted to the recess; and
a second sealing ring is provided at an upper end of the piston.

6. The faucet according to claim 1, wherein a size of a junction between the transfer cavity and the water outlet pipe is not greater than an inner size of the piston.

7. The faucet according to claim 1, wherein the water inlet pipe is a single cold water pipe or a dual hot-and-cold water pipe.
